(19) United States
(12) Patent Application Publication
(10) Pub. No.: US 2021/0231567 A1
(43) Pub. Date: Jul. 29, 2021

(54) DEVICE AND METHODS FOR OPTICALLY CHARACTERIZING FLUIDS AND/OR OBJECTS ENCLOSED THEREIN IN MICROCHANNELS

(71) Applicant: INSTITUT FÜR BIOPROZESS- UND ANALYSENMESSTECHNIK E.V., Heilbad Heiligenstadt (DE)

(72) Inventors: Karen LEMKE, Göttingen (DE); Robert RÖMER, Heilbad Heiligenst (DE); Andreas GRODRIAN, Heilbad Heiligenstadt (DE); Stefan WIEDEMEIER, Osterode (DE); Danny ECHTERMEYER, Lipprechterode (DE); Gunter GASTROCK, Heilbad Heiligenstadt (DE)

(73) Assignee: INSTITUT FÜR BIOPROZESS- UND ANALYSENMESSTECHNIK E. V., Heilbad Heiligenstadt (DE)

(21) Appl. No.: 17/264,860

(22) PCT Filed: Jul. 31, 2018
(86) PCT No.: PCT/EP2019/070640

§ 371 Date: Feb. 1, 2021

(30) Foreign Application Priority Data
Jul. 31, 2018 (DE) 10 2018 118 484.0

(51) Int. Cl. G01N 21/64; G01N 21/05; B01L 3/00

(52) U.S. Cl. CPC G01N 21/6458; B01L 3/502715; G01N 21/05

(57) ABSTRACT

The invention relates to a device (200) for the optical characterization of fluids and/or objects enclosed therein in a microchannel (13), comprising a measuring cell (10, 120), wherein the microchannel (13) is guided through the measuring cell (10, 120), characterized in that the measuring cell (10, 120) is filled with a liquid (14), the microchannel (13) is located within the measuring cell (10, 120) in the fluid (14), the fluid and/or objects enclosed therein are movable in the microchannel (13), and the microchannel (13) is movable within the measuring cell (10, 120) and/or the measuring cell (10, 120) with the microchannel (13) is movable manually or automatically. The invention further relates to a measuring cell (10, 120) for the device (200) and methods for optical characterization of fluids and/or objects enclosed therein in a microchannel (13) by means of the device (200).

### FIELD OF INVENTION

The invention relates to a device for the optical characterization of fluids and/or objects enclosed therein in a microchannel, comprising a measuring cell, wherein the microchannel is guided through the measuring cell, characterized in that the measuring cell is filled with a liquid, the microchannel is located within the measuring cell in the liquid, the fluid and/or objects enclosed therein are movable in the microchannel, and the microchannel within the measuring cell and/or the measuring cell with the microchannel is movable manually or automatically. The invention further relates to a measuring cell for the device and methods for optical characterization of fluids and/or objects enclosed therein in a microchannel by means of the device according to the invention.

### INVENTION BACKGROUND

Devices and methods based on microfluidic principles have become widely established in the laboratory sector. The advantages include lower consumption of reagents and sample materials per experimental set-up while simultaneously increasing the number of experimental sets-ups that can be carried out simultaneously. An example of this are wells of microtiter plates, in which up to 1536 parallel measurements are possible per plate. In addition to the established plate-based methods, so-called “droplet-based” microfluidic methods are increasingly gaining acceptance for biological and biomedical applications, among others.

So-called “pipe-based bioreactors” (pbb), such as those developed by the applicant, are already known. This is a modular cell cultivation system based on the principle of droplet- or compartment-based microfluidics and designed for medium to high throughputs. A microchannel, here formed by a tube, contains serially arranged droplets (compartments) consisting of biological media with cells inside. Each droplet can be regarded as a “microbioreactor”. The generally aqueous droplets are separated with a fluid immiscible with water, for example an oil. The tubing is made of polytetrafluoroethylene (PTFE) or fluoroethylene propylene (FEP) and has a length of several meters, is wound on a disc and holds a plurality of droplets. The tubular disk with the droplets inside can be cultivated in the incubator for up to several weeks, and the cells in the droplets are to be detected at specific intervals. In the simplest case, the tube disc is removed from the incubator and microscoped. However, due to the unfavorable optical and geometrical properties of the PTFE tube in particular and the different refractive indices n at the transition from air (n=1) to the PTFB tube (n=1.38), the optical resolution is limited and biological objects contained in the droplets cannot be reasonably imaged at 600× magnification or more. Since 3D cell structures (spheroids or even tissue fragments such as biopsies) are sometimes cultured in the droplets, the droplets must retain their shape. Therefore, tapering or stretching the drops for better microscopy is not possible and also for physical reasons (change of Laplace pressure) and would lead to the destruction of the drops and the cell structures inside. An alternative would be to transfer the droplets from the PTFE tube into a glass capillary of the same diameter. However, since glass has hydrophilic surface properties, a hydrophobic coating of the inner wall of the glass must be applied, for example using a plasma process. The lifetime of such plasma coatings proved to be too short, and after a short time, droplets adhered to the inner wall of the glass, thus destroying the droplet sequence. In addition, couplings between tubing and glass capillaries are problematic, as they can also initiate adhesion of droplets due to the geometric transitions. Transfer to polymer chips for microscopy is another alternative, and the lifetime of the plasma coating is greater on polymer surfaces than on glass. Polymer chips are generally suitable for transmitted light and epifluorescence microscopy, but not for special techniques such as light sheet microscopy, where the excitation light (laser light sheet) is coupled perpendicular to the direction of the detection objective. In addition, the refractive index of polymers (n=1.585 for polycarbonate (PC), see Table 1) is unfavorable and optical compensation would only be possible at great expense due to the mandatory circular cross-section of the microchannel in the polymer chip.

TABLE 1
Refractive indices n
of relevant materials.

| | |
|---|---|
| Water | n = 1.33 |
| Polycarbonate (PC) | n = 1.585 |
| Glass (cover glasses | n = 1.5255 |
| for microscopy) | |
| Perfluorodecalin (PFD) | n = 1.3145 |
| Polytretrafluoroethylene (PTFE) | n = 1.38 |
| Fluoroethylene propylene (FEP) | n = 1.344 |

Another challenge is the exact positioning of the droplets in the tube in the beam path of the optical image of a microscope. The drops are generally transported in the tube by means of syringe pumps or pressure-driven pumps. Syringe pumps must build up a minimum pressure to move the compartments. This pressure depends on the back pressure in the tube, which in turn depends on its length and the number of droplets in the tube. When this minimum pressure is reached, the drops begin to move and a constant pressure value is established. An exact stop of the moving drops for the purpose of positioning a drop in the beam path of the optical image is not possible due to a pressure hysteresis, i.e., there will be a run-on of the drop sequence until constant pressure conditions have been established in the tube again. The use of syringe pumps for exact positioning of the drops is therefore ruled out.

An alternative possibility for transporting liquids in microchannels is the use of peristaltic or roller pumps. However, these pumps are very often unable to overcome the pressure prevailing in the microchannels, which depends, among other things, on the length and diameter of the microchannels, and are therefore unsuitable. Another disadvantage is the non-uniformity of the liquid flow caused by the rollers of the peristaltic or roller pumps.

A characteristic feature of the movement of the drop sequence by means of pressure-driven pumps is that their fast start/stop behavior enables them to position the drops precisely in the area of the optical imaging beam path. A disadvantage is that the pressure-driven pumps must permanently regulate the pressure in the system and thus also in the tube, which results in a periodic movement (oscillation) of the droplets. Although this oscillation is small, it prevents accurate optical imaging of the droplet and the cells or 3D cell structures within it.

The combination of light sheet microscopy with flow cytometry is known to the skilled person and is discussed in US2014353522. Deschout, H. et al. (2014) describe studies of biological samples in microchannels of chip systems using light sheet microscopy. Paiè, P. et al. (2016) describe the study of tissue samples using microfluidic structures in a serial high-throughput method. However, the previously mentioned problems of exact sample positioning in the optical imaging beam path of a microscope and the poor quality of the images that can be generated at magnifications of more than 600× have not yet been solved.

### DESCRIPTION OF THE INVENTION

The task of the invention is therefore to overcome the disadvantages of the prior art and to develop devices and methods that enable improved optical detection (microscopy, spectroscopy) of samples located in a microchannel.

This task is solved by a device according to claim 1, a measuring cell according to claim 8, and a method according to claim 11.

In particular, the invention provides a device for the optical characterization of fluids and/or objects enclosed therein in a microchannel, comprising a measuring cell, a microchannel being guided through the measuring cell, characterized in that the measuring cell is filled with a liquid, the microchannel is located within the measuring cell in the liquid, the fluid in the microchannel and/or objects enclosed therein are movable in the microchannel, and the microchannel within the measuring cell and/or the measuring cell with the microchannel is movable manually or automatically.

The liquid with which the measuring cell is filled is selected from an aqueous or a non-aqueous liquid. In a preferred embodiment of the invention, the liquid with which the measuring cell is filled is an aqueous liquid, particularly preferably water, for example tap water, distilled water or deionized water, or water with specific properties such as buffers or cell culture nutrient medium.

In an alternative embodiment of the invention, the liquid with which the measuring cell is filled is a non-aqueous liquid, preferably an oil. It is particularly preferred if the measuring cell is filled with perfluorodecalin (PFD).

Particularly good results in terms of the quality of the images that can be obtained of the fluid and/or samples contained therein in the microchannel with a microscope are obtained when the refractive indices of the fluid with which the measuring cell is filled and the fluid that is in the microchannel and the material of which the wall of the microchannel consists are similar, i.e. comparable. Preferably, the liquid with which the measuring cell is filled and the fluid which is located in the microchannel and the material of which the wall of the microchannel consists have refractive indices of less than n=1.5, preferably of less than n=1.4, particularly preferably in the range from n=1.30 to 1.39, for example between n=1.31 and 1.38.

The microchannel is preferably a tube made of PTFE or FEP, since these materials have a refractive index similar to the refractive index of water (see Table 1) and have hydrophobic surface properties. It is particularly preferred if the tubing is made of FEP, since FEP has better optical properties, better transparency and better surface topography compared to PTFE.

The microchannel of the device according to the invention has an inner diameter between 50 μm and 2400 μm, preferably between 100 μm and 1800 μm, particularly preferably between 250 μm and 1200 μm, especially preferably between 500 μm and 1000 μm.

The fluid that is in the microchannel is a liquid and preferably biphasic and consists of serially arranged droplets consisting of biological media with cells, tissue fragments or 3D cell structures, such as spheroids, inside. Each droplet can be considered a “microbioreactor”. The aqueous droplets are separated with a liquid immiscible with water, for example an oil. In another embodiment of the invention, the fluid in the microchannel is a single-phase fluid, such as a nutrient medium, buffer solution, saline, or the like, with cells, tissue fragments, or 3D cell structures therein, and no droplet separation is performed by an oil or the like.

In another embodiment of the invention, the fluid in the microchannel is a multiphase fluid comprising serially arranged droplets in an oil or organic liquid consisting of biological media with cells, tissue fragments or 3D cell structures, such as spheroids, therein. Each droplet can be considered a “microbioreactor”. The aqueous droplets are separated with a liquid immiscible with water, such as an oil or organic liquid. Within the aqueous droplets, there may be at least one other non-aqueous phase, such as at least one oil droplet and/or at least one gas bubble and/or at least one organic liquid compartment and/or at least one gel-like compartment. A gas bubble may also be positioned between two aqueous droplets, for example to serve as an additional gas supply.

According to the invention, the microchannel is guided through a measuring cell filled with a liquid. This has the advantage that the liquid with which the measuring cell is filled can be selected so that its refractive index is comparable with the refractive index of the wall of the microchannel and of the fluid in the microchannel, which leads to an improvement in the quality of the images of the samples in the microchannel with a microscope. In addition, the fluid with which the measuring cell is filled can be conditioned so that diffusion of O₂ and/or CO₂ across the wall of the microchannel can occur and thus biological objects in the droplet can be supplied.

In a preferred embodiment of the invention, the position of the microchannel can be changed by translational and/or rotational movements, which also allows the position of the samples in the microchannel to be changed in a defined manner relative to the objective of the microscope while maintaining the position of the measuring cell relative to the objective. The movement of the microchannel can be manual or automated.

Alternatively, it is also possible to change the position of the entire measuring cell containing the microchannel, thereby changing the position of the samples in the microchannel in a defined manner relative to the objective of the microscope.

For the purposes of the invention, samples are understood to be droplets, compartments or segments of an aqueous medium in a two-phase or multiphase fluid, wherein the droplets are separated with a fluid that is immiscible with water, for example an oily fluid. A preferred oily fluid is perfluorodecalin (PFD), since this oil has a refractive index comparable to that of water. The droplets, compartments or segments separated by this oily fluid contain the actual microscopic objects such as cells, tissues or spheroids. If a single-phase fluid is used in the apparatus according to the invention, samples in the sense of the invention are understood to be the microscopic objects such as cells, tissues or spheroids located in the single-phase fluid.

In a particularly preferred embodiment, the measuring cell of the device according to the invention is filled with a liquid, such as water or an oil. The part of the microchannel that is to be introduced into the beam path of a microscope for optical analysis of the samples is located in the liquid in the measuring cell. This has the advantage that the liquid fills the topographical irregularities (manufacturing marks, etc.) on the outer surface of the microchannel, such as a sample tube, and thus guarantees undisturbed light transmission. Matching the refractive indices (water—FEP (or PTFE)—water or oil) further improves optical imaging (see Table 1 for refractive indices).

In a further embodiment of the invention, the device comprises a pump at the inlet of the microchannel into the measuring cell or at the inlet of the microchannel into the measuring cell and at the outlet of the microchannel from the measuring cell or at the outlet of the microchannel from the measuring cell. If the device includes only one pump at the inlet or at the outlet of the microchannel into or out of the measuring cell, this pump is preferably designed as a peristaltic or roller pump. Preferably, the device includes a pump at the inlet of the microchannel into the measuring cell and at the outlet of the microchannel from the measuring cell. In a particularly preferred embodiment, these pumps are designed as pressure pumps, with the pump at the outlet of the microchannel from the measuring cell operating with negative pressure. With the use of pressure pumps, the problem of run-on of the droplet sequence described at the beginning can be avoided particularly effectively. Preferably, the pumps are coupled to a means or system for determining the sample position. The signal from this system switches off the pump(s) in a defined manner and the drop sequence stops immediately. This enables a defined preselection of the sample position in the area of the beam path of the optical image of a microscope.

The already described oscillation of the samples, such as the droplets in a microchannel, due to the necessary control of the pump(s), is eliminated according to the invention by fluidically decoupling the pump(s) from the microchannel, such as a sample tube, and thus from the droplet sequence during optical detection. For this purpose, according to a further embodiment, the device according to the invention has a valve (stopcock) between the pump and the measuring cell at the inlet of the microchannel into the measuring cell and/or another valve (stopcock) between the pump and the measuring cell at the outlet of the microchannel from the measuring cell. It is important that the stopcocks do not cause any volume displacement in the sample tubing. Otherwise, the samples would move in an undefined, erratic manner In addition, the samples must not be transported by the operation of the stopcocks, which would lead to undefined adhesion effects in the stopcocks. After sample detection is complete, the stopcocks switch back to passage and the pumps convey the next sample in the sample sequence into the optical imaging area of the microscope.

In one embodiment of the device according to the invention, the measuring cell has a closed housing and the inlet of the microchannel into the measuring cell and the outlet of the microchannel from the measuring cell have means for sealing the microchannel with respect to the housing of the measuring cell, which allow the microchannel to be moved within the measuring cell while preventing the fluid from escaping from the measuring cell. The inlet of the microchannel into the measuring cell and the outlet of the microchannel from the measuring cell are disposable on each outer surface of the measuring cell. In one embodiment of the invention, the inlet of the microchannel into the measuring cell is arranged on one outer surface of the measuring cell and the outlet of the microchannel is arranged on the opposite outer surface of the measuring cell. In another embodiment of the invention, the inlet of the microchannel into the measuring cell and the outlet of the microchannel from the measuring cell are arranged on the same outer surface.

In a further embodiment of the device according to the invention, the measuring cell has a housing which is open on one side and through which the microchannel protrudes into and out of the measuring cell, wherein the part of the microchannel protruding into the measuring cell and the part of the microchannel protruding out of the measuring cell being fixedly connected by a means which can be moved in all spatial directions and which is not connected to the measuring cell.

In a further embodiment of the device according to the invention, the measuring cell has passages for filling the measuring cell with a liquid, for venting the measuring cell, for passing light sources and sensors, for example optical fibers for coupling light into the measuring cell or light barriers or electrodes for determining the position of samples in the microchannel, or for passing objectivs for emitting and detecting electromagnetic radiation.

By connecting optical fibers that can couple light into the samples in the microchannel, it is possible to excite the samples (cells) in the drops of a sample tube on one or both sides via optical fibers, for example for fluorescence microscopy. Spectroscopic (turbidimetry, nephelometry, etc.) measurements and combinations of different optical detection methods can thus be realized in an advantageous manner It is possible to realize several optical and fluidic inputs/outputs arranged in parallel at the measuring cell.

In a preferred embodiment of the device according to the invention, the measuring cell has a frame with seals for the microchannel and two plates connected to the frame in a liquid-tight manner (e.g. seals, adhesive connections) and made of transparent material, preferably a plastic or glass, particularly preferably glass, for the optical beam path of the microscope objective. The measuring cell has a led-through microchannel, such as a sample tube, which is introduced into the measuring cell via an inlet and is led out of the measuring cell via an outlet. Further connections of the measuring cell are used for filling the chamber with the aqueous liquid and for venting the chamber. The microchannel, such as a sample tube, can be advanced or retracted through the chamber via the inlet and outlet and/or rotated about the axis of the sample tube. This makes it possible to position the samples, e.g. compartments, droplets, in the sample tube exactly in the range of the beam path of the microscope objective. This possibility of pulling and rotating the sample tubing is essential in the case of using syringe pumps for sample transport, since exact positioning of the drops is not possible with syringe pumps. In the case of using pressure-based pump systems, exact positioning of the sample is possible even without the relative movement of the tube. The two plates for sealing the measuring cell can be cover glasses, for example.

In another embodiment of the device according to the invention, the measuring cell has ports connected to a conditioning module, wherein a pump delivers conditioned fluid from the conditioning module through the measuring cell and back to the conditioning module.

Conditioning of the fluid, which is then introduced into the measuring cell and surrounds the microchannel, may include, for example, the following parameters: Water temperature T, O₂- and CO₂-concentration. Gas exchange is possible within certain limits, for example, via a PTFE tube. This allows conditioning of the O₂ and pH of the fluid in the microchannel, especially in the droplet. The possibility of conditioning thus also allows longer-lasting investigations in the measuring cell.

The measuring cell of the device according to the invention is made of optically transparent materials or optically non-transparent materials or a combination or composite of optically transparent and non-transparent materials, such as glass, suitable plastics, metal or combinations or composites thereof.

In a further embodiment of the device according to the invention, the measuring cell is a glass cuvette. This has a lid and a base in which the microchannel is sealed and guided so that it can be rotated and moved. The glass cuvette is filled with an aqueous liquid. The illumination can again be on both sides.

In a further embodiment of the device according to the invention, the measuring cell is a measuring cell for immersion objectives, which in turn is filled with an aqueous liquid and uses immersion objectives. The microchannel feedthrough and microchannel movement are analogous to the previously presented embodiments of the measuring cells.

In one embodiment, the measuring cell can be closed. The feedthroughs for the microchannel are then provided with seals. Depending on the microscope used, it may be constructively preferred that the inlet and the outlet of the microchannel take place on one surface of the measuring cell, preferably on one side, such as on its lid. The microchannel, for example a sample tube, can be pulled at one end and pushed in the same way at the other end at the same time, or pulled at one end only, or pushed at one end only, or pulled or pushed at both ends at the same time, in order to position the samples, e.g. compartments, drops, located in the sample tube exactly in the area of the beam path of the microscope objective.

In another particularly preferred embodiment, the measuring cell is open at the top but also filled with a liquid. In this case, the microchannel, such as a sample tube, is not fixed to the measuring cell, but independently of the measuring cell. The sample tube fixed in this way can be moved as a whole in all spatial directions and can also be rotated within certain limits in order to position the samples, e.g. compartments or drops, located in the sample tube exactly in the area of the beam path of the microscope objective.

In a further embodiment of the device according to the invention, the measuring cell additionally has a metering module. The metering module has a microvalve for the defined and precise addition of active ingredients to the samples in the microchannel and means for positioning the samples in the microchannel in the beam path of a microscope, such as light barriers, measuring electrodes, sensors or a camera. Thus, on the one hand, samples in the microchannel, e.g. compartments or droplets, can be positioned exactly in the range of the beam path of the microscope objective in an advantageous manner On the other hand, it is possible to perform in situ investigations on the samples by adding active ingredients, test substances, etc. directly to the samples in the microchannel Due to the large number of separate and serially arranged samples in a two-phase or multi-phase fluid in the microchannel, it is therefore possible to perform a large number of different examinations and tests in a short time or to investigate the effect of a large number of test substances in a high-throughput manner

Through the connections provided on the measuring cell, it is also possible to exchange the fluid present in the measuring cell and to adjust its composition so that the fluid has a refractive index comparable to the wall of the microchannel and the fluid present in the microchannel In a particularly preferred embodiment, the device according to the invention therefore comprises a means for adjusting the refractive index of the fluid in the measuring cell. This is, for example, a system with at least one storage container for liquids and at least one pump as well as corresponding tubes, with the aid of which the measuring cell can be filled with the desired liquid.

The device according to the invention is particularly suitable for use on an upright or inverted microscope. It was shown that the quality of optical imaging of cells in droplets contained in PTFE tubing placed in a water-filled measuring cell could be significantly increased compared to imaging of cells in droplets contained in PTFE tubing not placed in a water-filled measuring cell. By using FEP tubing with higher transparency compared to PTFE tubing, the quality of the optical imaging can be further increased. Likewise, with a miniaturization of the measuring cell and a reduction in the wall thickness of the tubing as a result of the shorter optical path lengths, a further improvement in image quality can be achieved.

The device according to the invention can be designed, as described below, so that sample positioning in the beam path of an optical image is automated. Thus, the device according to the invention can also be used in an advantageous manner in light sheet microscopy and can be used for sample examination in high throughput. For this purpose, the microchannel of the device according to the invention may, in a further embodiment, be contained in a tubular probe. For example, the measuring cell may be a measuring cell suitable for use in a light sheet microscope, wherein the measuring cell for the light sheet microscope is also filled with a liquid, resulting in the improvement of the quality of the optical imaging of samples in the microchannel The microchannel in the tubular probe can preferably be positioned in the liquid-filled measuring cell of a light sheet microscope.

The measuring cell for the light sheet microscope is preferably open at the top and has at least one bore for inserting an objective for fluorescence measurement and/or at least one bore for inserting an illumination objective for a light sheet. Preferably, the measuring cell for the light sheet microscope has one bore for inserting an objective for fluorescence measurement and two bores for inserting two illumination objectives, offset by 180°, for two light sheets.

In a further embodiment, the device according to the invention comprises at least one means for determining the position of samples in the microchannel, preferably at least one light barrier, camera, measuring electrode or sensor. This embodiment of the device according to the invention is particularly advantageous because it allows the samples in the microchannel, such as droplets in a sample tube containing a two-phase or multiphase fluid, or cells and/or spheroids in a microchannel containing a single-phase fluid, to be positioned precisely in the region of the optical imaging beam path. In combination with pumps, the system also operates in an automated manner The output signal from the means for determining the position of samples switches off the pump(s) in a defined manner and the fluid containing the samples stops immediately. This allows a defined preselection of the sample position in the range of the optical imaging beam path. The already described oscillation of the samples due to the necessary control of the pump(s) is eliminated by fluidically decoupling the pump(s) from the microchannel and thus from the sample sequence during optical detection. This can be done by means of stopcocks located in the area between the pressure pumps and the measuring cell.

The combination of a measuring cell open at the top with the pump-based sample transport system offers excellent conditions, for example, for tomographic image acquisition procedures in serial throughput. A fine adjustment would be desirable, for example to be able to generate tomographic images of the sample. This problem is solved by a further embodiment of the device according to the invention, wherein the device comprises a means for automatically moving the tubular probe, which comprises a microchannel, within the measuring cell of the light sheet microscope filled with a liquid, preferably a piezo drive. This means for automatically moving the microchannel is used for fine adjustment and allows to move the sample tube in arbitrary directions in space and thus to characterize the sample from different directions or to generate z-stacks and thus to realize a spatial characterization of the samples and the cells and/or 3D cell structures present in the samples.

The invention further provides a measuring cell for optical characterization of fluids and/or objects enclosed therein in microchannels.

A microchannel is guided through the measuring cell, the measuring cell having passages for filling the measuring cell with a liquid, for venting the measuring cell, for passing through light sources and sensors, for example optical fibers for coupling light into the measuring cell or light barriers or electrodes for determining the position of samples in the microchannel, or for passing through lenses for emitting and detecting electromagnetic radiation. According to the invention, the measuring cell is filled with a liquid, the microchannel is located within the measuring cell in the liquid, and the microchannel within the measuring cell and/or the measuring cell with the microchannel can be moved manually or automatically.

The device and the measuring cell are advantageously suited to enable a defined preselection of the sample position in the area of the beam path of the optical imaging of a microscope and to provide optical images of samples in the microchannel in improved quality. The generation of optical images of samples in the microchannel is more automated with the device according to the invention and is adaptable for the examination of samples in high throughput. Further embodiments of the device according to the invention allow tomographic images to be generated in serial throughput.

In this context, the invention also provides a method for optically characterizing fluids and/or objects enclosed therein in a microchannel by means of the device described herein, wherein the microchannel is located within a measuring cell according to the invention which is filled with a fluid, and the method comprises the steps:
a) Providing a sample-containing single-phase, two-phase, or multiphase fluid in a microchannel; and
b) Positioning of the samples contained in the microchannel in the area of the beam path of the optical image of a microscope,

characterized in that the positioning of the samples contained in the microchannel in the region of the beam path of the optical image is effected by
c) manual axial displacement and/or rotation of the microchannel relative to the measuring cell; or
d) automatic movement of the microchannel within the measuring cell filled with a liquid, preferably by means of a piezo drive;
e) automatic or manual movement of the measuring cell filled with a liquid and containing the microchannel by moving the microscope stage in the three spatial directions.

In a preferred embodiment, automatic movement of the measuring cell filled with a liquid and containing the microchannel is performed by moving the microscope stage in the three spatial directions using stepper motors.

In a further embodiment of the method according to the invention, the positioning of samples contained in the microchannel can be performed by
f) Moving the droplets in the sample tube by means of one or more pumps and stopping the pump(s) when the sample is in the optical imaging path; or
g) accurately moving the droplets in the sample tube by means of one or more pumps, stopping the pump(s), and fluidically decoupling the pump(s) from the droplet sequence in the microchannel by means of valves from the droplet sequence in the sample tube when the sample is in the optical imaging path.

It is particularly preferred if, in the method according to the invention, the positioning of samples contained in the microchannel is performed by
h) automatic detection of samples in the microchannel by means of a means for determining the position of the samples in the microchannel, preferably by means of a camera, a measuring electrode or by means of light barriers, and stopping the pump(s) when the sample is in the range of the optical imaging beam path.

For moving the droplets in the sample tube, for example, a peristaltic pump (roller pump) or pressure pumps, which preferably operate at different pressures (pressure, negative pressure), with changing pressure ratios being controlled by means of pressure sensors, can be used.

The same preferred designs and embodiments apply to the measuring cell according to the invention and the method according to the invention as described for the device according to the invention, so that reference is made to the detailed description of the device according to the invention and further repetition is dispensed with.

The device and method according to the invention have numerous advantages. For droplet-based microfluidics and in particular for the technological platform “pipe based bioreactors”, the fast, reproducible and high-resolution optical detection of biological samples plays a dominant role. The device and method according to the invention can be used as a simple flow system for routine microscopic/spectroscopic examinations up to applications for automated tomography-based imaging methods and thus have a broad application potential. For both the measuring cell in the light sheet microscope and the measuring cell on the upright/inverted microscope, there is also the possibility of uniform, continuous flow of the droplets. In the case of the light sheet microscope, tomographic examinations could thus be carried out in flow. The prerequisite is that the images can be acquired fast enough and processed by the PC. This has already been successfully demonstrated by Jiang, H. et al (2017). Similarly, it is possible to investigate single-phase fluids or objects in them, such as cells or 3D cell structures. For the single-phase fluids, it is also possible to investigate these or 3D cell structures located in them continuously or in start-stop mode.

The invention is illustrated in more detail below with reference to 12 drawings.

It show:

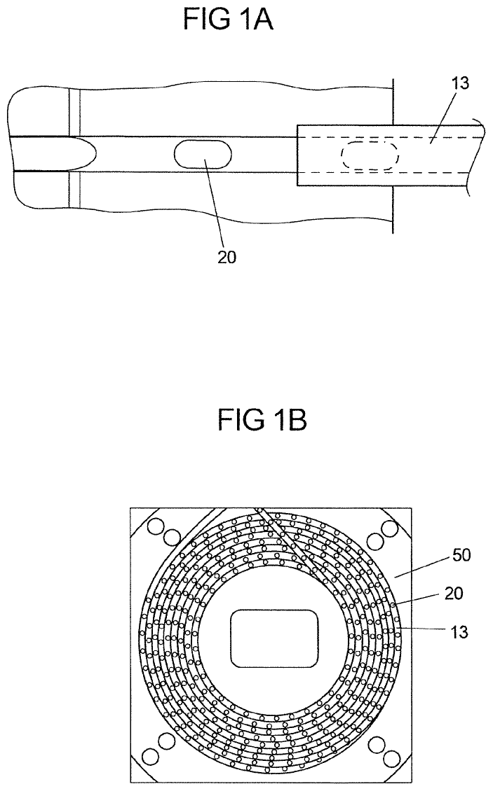

FIG. 1 the preparation of droplets from cell culture medium (DMEM, gray) compartmented in an oily fluid (PFD, transparent);

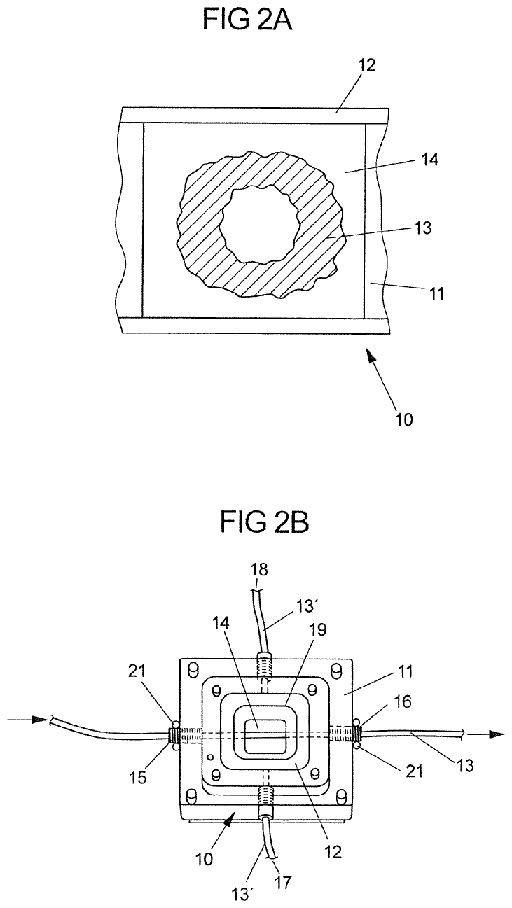

FIG. 2 the structure of a measuring cell according to the invention;

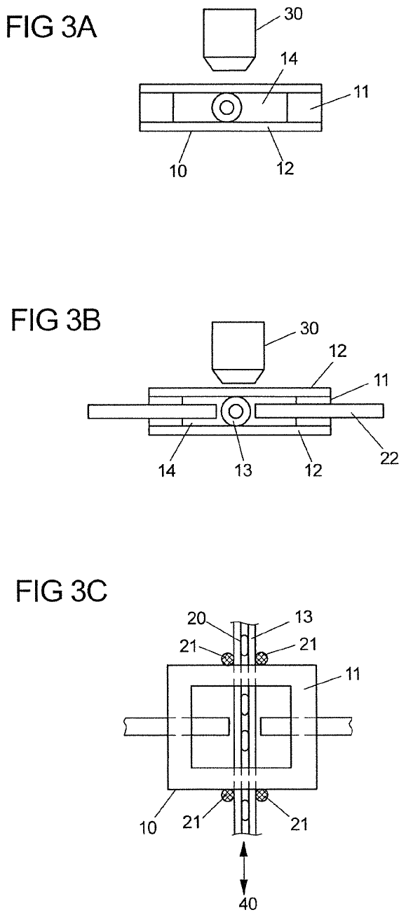

FIG. 3 an embodiment of the measuring cell according to the invention as a microscopy cell;

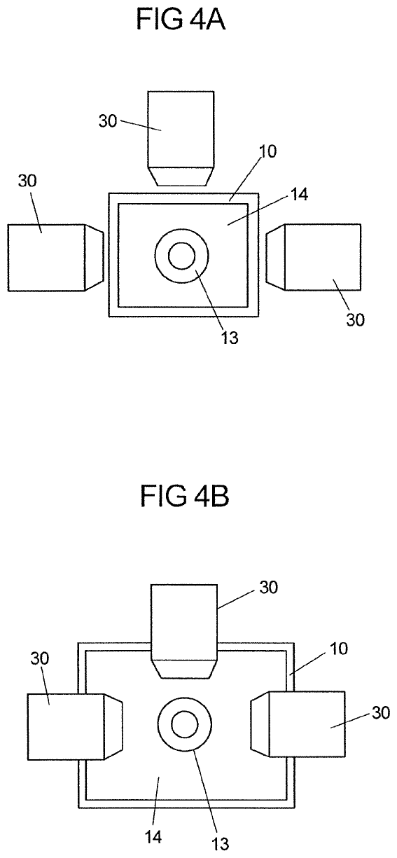

FIG. 4 further embodiments of the measuring cell as a glass cuvette and as a material-independent measuring cell with immersion objectives;

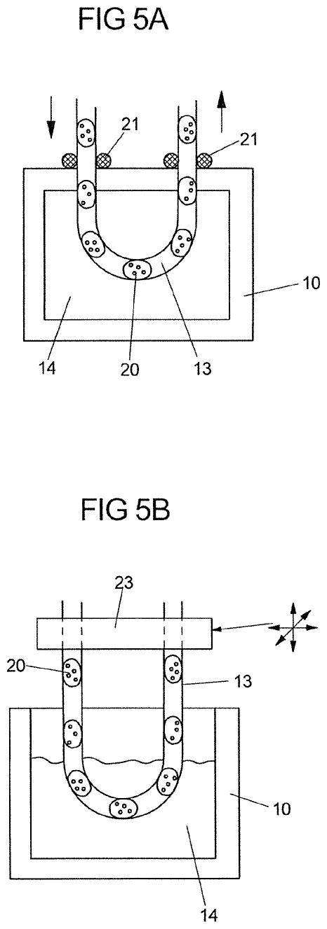

FIG. 5 further embodiments of the measuring cell with one-sided inlet and outlet of the tube, as a closed measuring cell and as a measuring cell open at the top;

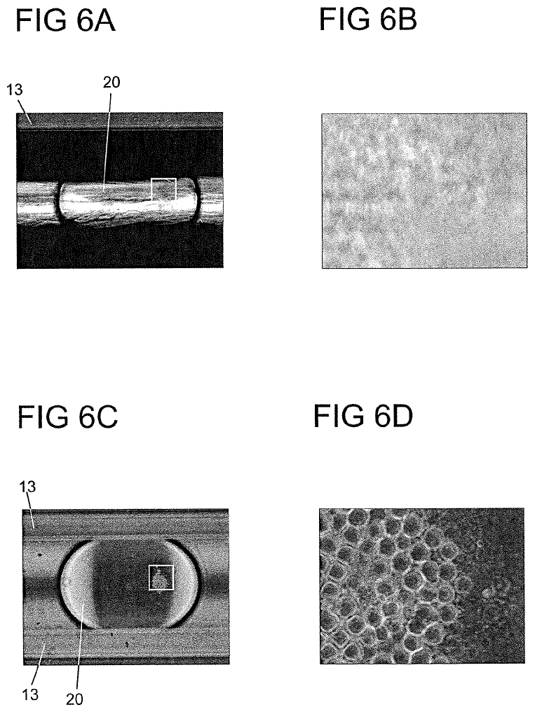

FIG. 6 the differences between microscopic images of cells in droplets contained in a PTFE, tube with and without a measuring cell according to the invention;

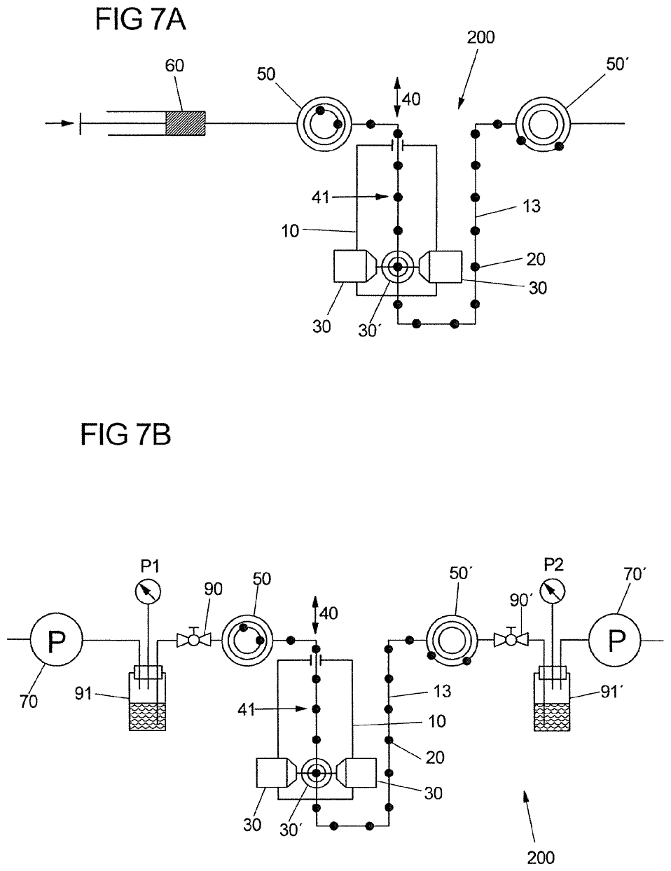

FIG. 7 variations for moving and positioning the droplets in the optical path of the optical image of a microscope;

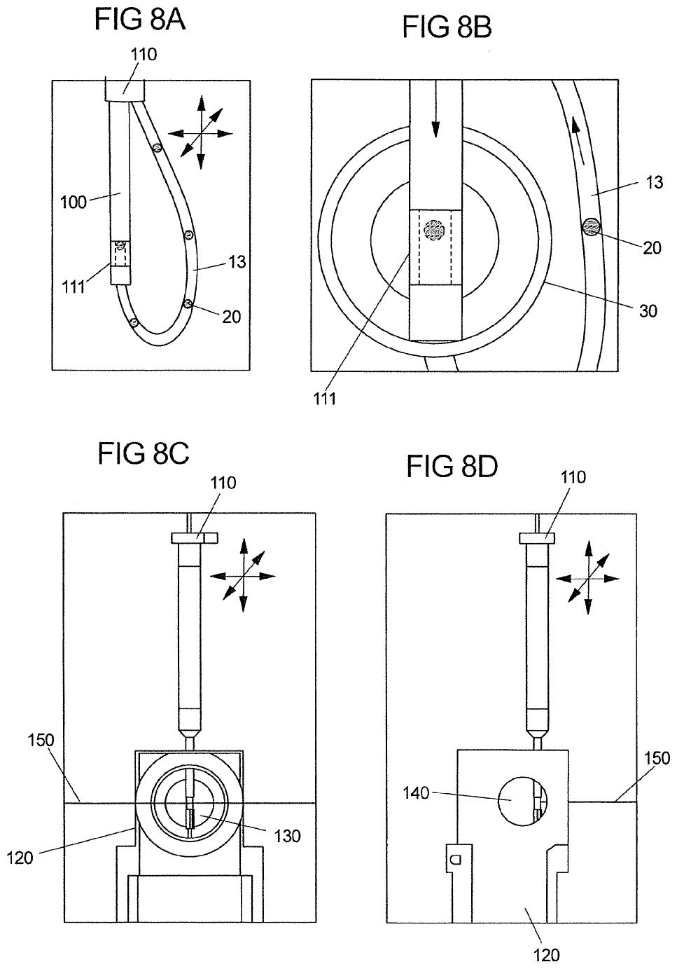

FIG. 8 schematic illustration of the measuring cell for a light sheet microscope;

FIG. 9 a schematic illustration of the fluidic regime on the light sheet microscope;

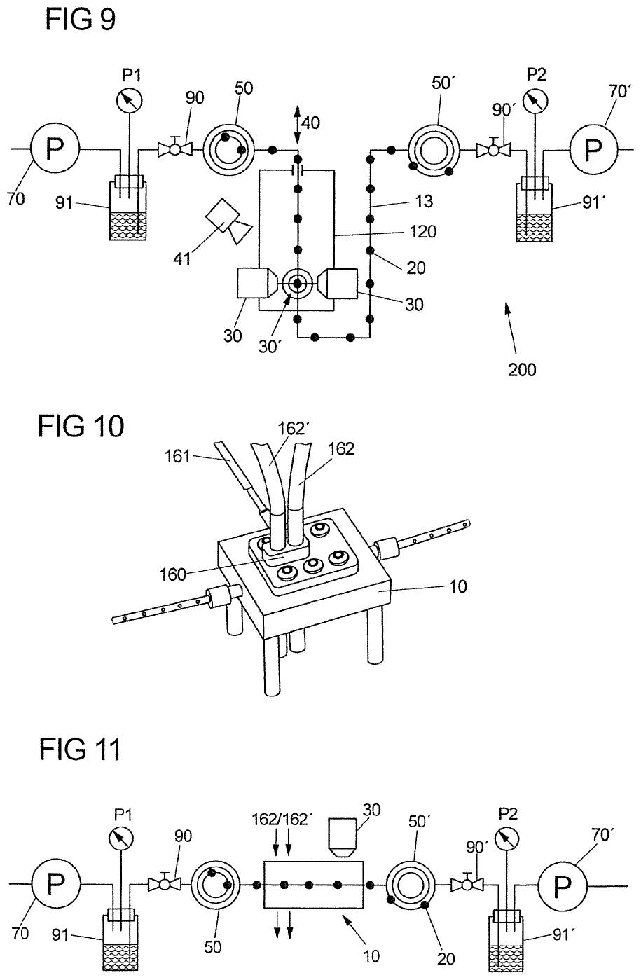

FIG. 10 a metering module for the measuring cell according to the invention based on the determination of position and speed of the samples by means of two light barriers;

FIG. 11 schematic illustration of the fluidic regime on the upright or inverted microscope; and

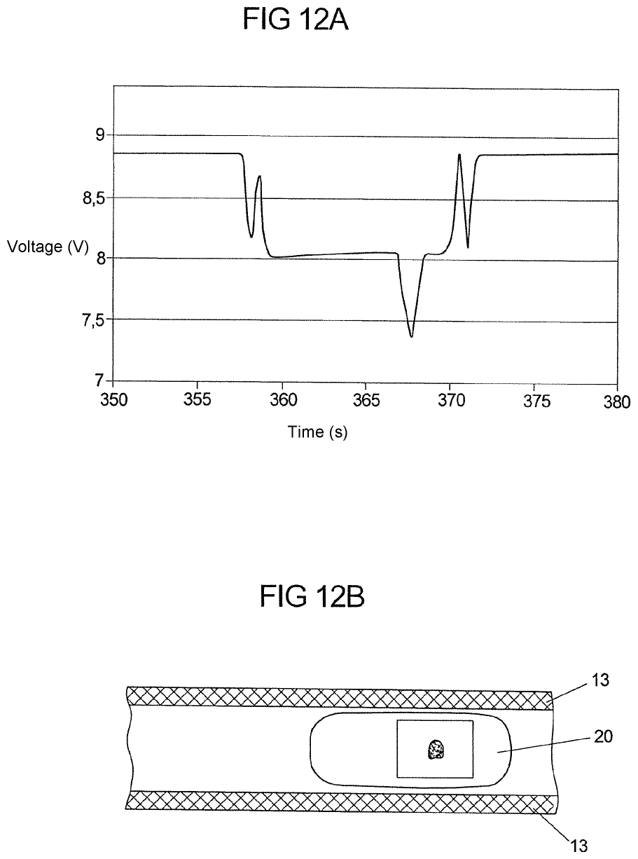

FIG. 12 the position recognition of stem cell spheroids in a droplet in a microchannel

FIG. 1 shows parts of a prior art “pipe based bioreactor” (pbb). Droplets (20) of cell culture medium (DMEM, colored gray) are generated in a microfluidic module made of polycarbonate and are separated by an oily fluid (PFD, transparent). FIG. 1A illustrates the droplet generation. In the right area of the channel of the microfluidic module is the connection of the sample tubing (13).

FIG. 1B shows the droplet sequence in a sample tube (13) wound onto a tube disk (50). The tube disk (50) with the compartments (droplets (20)) contained therein can be cultivated in the incubator for several weeks, whereby a detection of the cells contained in the droplets (20) must be carried out at certain intervals. In the simplest case, the tube disc (50) is removed from the incubator and microscoped.

Each droplet (20) can be regarded as a “microbioreactor”. The aqueous droplets (20) are separated with a fluid that is immiscible with water, for example an oil. In the case shown here, this fluid is perfluorodecalin (PFD). PFD is completely biologically inert, has a high oxygen absorption capacity and is used in the medical field, for example, to transport transplants. The sample tube (13), preferably made of either polytetrafluoroethylene (PTFE) or fluoroethylenepropylene (FEP) due to the need for hydrophobic surface properties, preferably has a length of three meters, is wound on a disc (50) (FIG. 1B) and holds up to 900 drops.

FIG. 2A shows a section through a measuring cell (10) and illustrates the task of the liquid (14) contained in the measuring cell (10). In the case shown here, this is water. The water (14) compensates for unevenness of the outer surface of the sample tube (13) and thus prevents light scattering, which in the case without water (14) (refractive index n_{Water}32 1.333) would be significant when light passes from air (refractive index n_{Air}=1) into the sample tube (13) (refractive index n_{FEP}=1.344) and from the sample tube (13) back into the air. Scattering effects would cause significantly worse imaging (see also FIGS. 6A and 6B) than when using water (14) as the ambient medium (see FIGS. 6C and 6D). FIG. 2B shows the technical realization of the measuring cell (10) as a microscopy module with the sample tube (13) passed through, (15: inlet, 16: outlet) as well as the connection (17) for filling the measuring cell (10) with an aqueous liquid (14) and connection (18) for venting the chamber of the measuring cell (10). The sample tube (13) can be pulled through the measuring cell (10) via the connections (15), (16) (in the direction of the arrows or in the reverse direction) and/or rotated around the axis of the sample tube (13). This makes it possible to position the samples (20), e.g. compartments, located in the sample tube (13) exactly in the area of the beam path of the microscope objective (not shown). This ability to pull and rotate the sample tubing (13) is essential in the case of using syringe pumps for sample transport, as exact positioning of the drops (20) is not possible with syringe pumps. In the case of using pressure-based pump systems, exact positioning of the drops (20) is also possible without the relative movement of the tube (13). Glass plates (12) (cover glasses: n_{glass}=1.5255) were used to seal the chamber of the measuring cell (10). This is advantageous because the light transitions can be optically corrected.

The measuring cell (10) can be connected to an external conditioning module, e.g. via the connections (17) and (18) in FIG. 2B, and a pump then delivers conditioned liquid from the conditioning module through the measuring cell (10) and back to the conditioning module (circuit) via the tube (13′). The conditioning of the fluid (14) may include the following parameters: Water temperature T, O₂ and CO₂ concentration. Gas exchange is possible within certain limits, for example, via a sample tube (13) made of PTFE, thus conditioning of the O₂ and pH in the droplet (20) is possible. The possibility of conditioning thus also allows longer-lasting investigations in the measuring cell (10).

By means of the connections (17, 18) provided on the measuring cell (10), it is also possible to exchange the liquid (14) present in the measuring cell and to adjust its composition so that the liquid (14) has a refractive index comparable to the wall of the sample tube (13) and the fluid present in the sample tube (13). For this purpose, the device (200) may have a means for adjusting the refractive index of the fluid (14) in the measuring cell (10). This is, for example, a system with at least one storage container for liquids and at least one pump as well as corresponding tubes (13′), with the aid of which the measuring cell can be filled with the desired liquid (14).

FIG. 3 shows an embodiment of the measuring cell (10). FIG. 3A shows the simplest embodiment of the arrangement of the measuring cell (10) as a microscopy cell. The position of the objective (30) for light microscopy or epifluorescence microscopy can be seen. In the space formed by the frame (11) and the glass windows (12), the liquid (14) is water or alternatively an oil, such as perfluorodecalin. The connections (17) and (18) shown in FIG. 2B for filling the chamber of the measuring cell (10) can also be occupied by, for example, optical fibers (22) that couple light into the samples (20) in the tube (13) and excite fluorescent dyes therein (FIG. 3B). Spectroscopic (turbidimetry, nephelometry, and others) measurements and combinations of different optical detection methods are feasible. It is possible to realize several optical and fluidic inlets/outlets arranged in parallel in the area of connections (17) and (18). FIG. 3C shows the top view of the image shown in FIG. 3A.

FIG. 4 shows further embodiments of the measuring cell (10). In FIG. 4A, the tube (13) is guided through a measuring cell (10), which is designed as a glass cuvette. This has a lid and a base in which the sample tube (13) is sealed and guided in a rotatable and displaceable manner (comparable with FIG. 2). The measuring cell (10) is filled with a liquid (14), such as water or an oil. The illumination can again be on both sides. FIG. 4B shows an arrangement with a material-independent housing of the measuring cell (10), which is again filled with a liquid (14), such as water or an oil, and uses immersion lenses (30). The tube feed-through and tube movement are analogous to the variants of the measuring cells (10) presented so far.

FIG. 5 shows further embodiments of the measuring cell (10). In FIG. 5A the measuring cell (10) is closed, filled with water (14) and the tube passages are provided with seals (21). The sample tube (13) can be pulled at one end and pushed in the same way at the other end at the same time, or pulled at one end only, or pushed at one end only, or pulled or pushed at both ends at the same time. In FIG. 5B, the measuring cell (10) is open at the top but also filled with water (14). In this case, the sample tube (13) is not fixed to the measuring cell (10) (compare FIG. 5A), but independently of the measuring cell (10). The sample tube (13) fixed in this way can be moved as a whole in all spatial directions and also rotated within certain limits. The two embodiments shown in FIG. 5A and FIG. 5B can be realized both as a glass cuvette and as a material-independent housing (compare FIG. 4). “Material-independent” housing means that the housing can be made of any suitable material, such as glass, a plastic, a metal, or combinations or composites thereof, provided that the in this case feedthroughs can be made in the walls of the housing to allow lenses (30) of a microscope, as shown in FIG. 4B, to be inserted into the measuring cell (10).

FIG. 6 illustrates the differences between microscopic images of cells in droplets (20) contained in a PTFE, sample tube (13). FIGS. 6A and 6B were taken through a sample tube (13) without a measuring cell (10), in FIGS. 6C and 6D the sample tube (13) was in a measuring cell (10) filled with water (14) (compare FIG. 2B). KG1 cells in RPMI medium, segmented with PFD in comparable sample tubes (13) (PTFE tube, dᵢ=1.0 mm, dₐ=1.60 mm) were examined Phase contrast imaging was performed under the following conditions:
FIG. 6A: 40× magnification, without measuring cell (10).
FIG. 6B: 600× magnification, focused on cell collection in the area of the marked square in FIG. 6A, without measuring cell (10).
FIG. 6C: 40× magnification, with measuring cell (10) filled with water (14).
FIG. 6D: 600× magnification, focused on cell collection in the area of the marked square in FIG. 6C, with measuring cell (10) filled with water (14).

FIG. 7 shows two variants for moving and positioning the droplets (20) in the area of the beam path of the optical imaging by means of the device (200) according to the invention. Shown here is a special variant for microscopic characterization of droplets (20) and cells therein in a light sheet microscope, indicated by the objectives (30) of the light sheet microscope. FIG. 7A shows the relatively simple setup based on a syringe pump (60). FIG. 7B shows the setup with pumps (70, 70′). The pumps (70, 70′) are designed here as pressure pumps. In order to be able to position the droplets (20) exactly in the area of the optical image, a droplet position determination (41) is required. This can be done by means of a light barrier, but can also be realized with a camera and fast image evaluation. The output signal of the drop position determination (41) switches off the pump (60), whereby in the case of the syringe pump the drop sequence continues to move and only comes to a stop after pressure compensation in the sample tube (13). The technical solution shown in FIG. 7B is based on the use of pressure-based pumps and avoids the problem of the drop sequence tracking described above. Here, too, a system for determining the drop position (41) is required. The signal from this system switches off the pressure pumps (70, 70′) in a defined manner and the drop sequence stops immediately. This enables a defined preselection of the drop position in the beam path of the optical image. The already described oscillation of the drops due to the necessary control of the pressure pumps (70, 70′) is eliminated by fluidically decoupling the pressure pump(s) (70, 70′) from the sample tube (13) and thus from the drop sequence during optical detection. This can be done by means of stopcocks (90, 90′) arranged in the area between the pressure pumps (70, 70′) and the measuring cell (10). It is particularly advantageous if the stopcocks (90, 90′) do not cause volume displacement in the sample tube (13), otherwise the droplets (20) would perform undefined erratic movements; and that the droplets (20) are not transported through the stopcocks (90, 90′), which is given by the positioning of the stopcocks (90) and (90′) between the reservoir and the tube disk (50, 50′). Otherwise, this would lead to undefined adhesion effects in the stopcocks (90, 90′). After droplet detection is complete, the stopcocks (90, 90′) switch back to passage, and the pressure pumps (70, 70′) deliver the next droplet of the droplet sequence into the optical imaging area of the microscope. Fine adjustment (40) can be made, for example, by moving the microscope stage or by a piezo actuator. Thus, the combination of an open measuring cell (compare FIG. 5B) with the droplet transport system with pressure pumps (70, 70′) according to FIG. 7B offers excellent conditions, for example, for tomographic image acquisition procedures in serial throughput. The fine adjustment (41) makes it possible to move the sample tube (13) in any direction (e.g., with piezo actuators) and thus to characterize the droplets (20) from different directions or to generate z-stacks and thus to realize a spatial characterization of the droplets (20) and the cells or 3D cell structures located in the droplets (20). The cells or 3D cell structures are cultured in tubular discs (50, 50′) for a predetermined duration. To transport the samples (20) in the sample tube (13), fluid is pumped from the reservoir (91) into the reservoir (91′) or vice versa by means of the pressure pumps (70, 70′).

In a simpler embodiment, the device (200) according to the invention can also include a peristaltic pump instead of the pressure pumps (70, 70′). The stopcocks (90, 90′) can then be omitted if necessary.

FIG. 8 shows details of a tube probe (100) with microchannel or sample tube (13), which was specially developed and tested for the measuring cell (120) of a light sheet microscope. The measuring cell (120) is locally locked in the light sheet microscope, but can be removed and reinserted by the user. The two illumination objectives (compare (30) in FIGS. 7A and 7B), which are offset by 180°, project into the measuring cell (120), as does an objective for detecting fluorescence (compare FIG. 8C). The measuring cell (120) is filled with water or a non-aqueous liquid. This serves to equalize the refractive indices. The tube probe (100) with sample tube (13) projects freely into the measuring cell (120) and the liquid therein, but is connected to the piezo drive (110) of the light sheet microscope, which can move and rotate the tube probe (100) in three spatial directions.

FIG. 5B shows a schematic illustration of the tube probe (100) with microchannel or sample tube (13), positioned in the measuring cell (10) of a light sheet microscope. FIG. 8A shows the part of the tubular probe (100) with sample tube (13) positioned in the measuring cell (120). FIG. 8B shows the tube probe (100) in the measuring cell (120), taken with the door camera (41) of the light sheet microscope. The tube probe (100) has a microscope window (111) located in the optical imaging beam path of the microscope. FIG. 8C shows a 3D view of the measuring cell (120) and the tubular probe (100) (FIG. 8B “out of the sheet”, the hole (130) is provided to accommodate an objective for fluorescence measurement, see also FIG. 9). FIG. 8D shows the side view of FIG. 8C. The hole (140) is provided for the insertion of one of the two illumination lenses offset by 180° for the light sheets 1 and 2 (see also FIG. 9).

FIG. 9 shows a schematic illustration of the fluidic regime on the light sheet microscope. For the optical images of the cell cultures in the droplets (20), it is essential that the droplets (20) do not change their position in the sample tubing (13) during the images, which can last up to several minutes and would result in blurred images. The changes in the position of the biological objects located in the droplet (20) that are necessary for the tomographic images are made by the movement of the complete tube probe (100) by the piezo drive (110) of the light sheet microscope, see FIG. 8. For the droplets (20), two states result: i) during the measurement, the droplets (20) in the sample tube (13) must not move and ii) after the measurement, the complete droplet sequence in the sample tube (13) must be moved in such a way that the next droplet (20) enters the focal plane of the objectives (30) and is stopped there in a defined manner The realization of these two states is described below:

The pumps (70, 70′) generate an overpressure P1 and a negative pressure P2 in the two reservoirs (91, 91′), respectively Immediately after application of the pressure, the droplets (20) begin to move uniformly out of the tube disk (50) in the direction of the measuring cell (120). The area of the window (111) of the tube probe (100) (FIG. 8B) is monitored by a video camera (41) (door camera of the light sheet microscope) and the results are permanently transferred to a Matlab program. A light intensity of an imaginary line ((150) in FIGS. 8C and 8D) is evaluated. If a droplet (20) in the sample tube (13) enters this area of the window (111) of the tube probe (100), the light intensity in the area of this line (150) changes, which is evaluated by Matlab and then output as a signal to stop the pumps (70, 70′). The droplet sequence then stops immediately, and the droplet (20) to be measured is in the area of the optical path of the light sheet microscope. The pumps (70, 70′) still regulate to a certain pressure value, which would manifest itself in a “trembling” of the drop (20). To avoid this, immediately after the drop sequence stops, valves (90) and (90′) switch and decouple the pumps (70, 70′) and reservoirs (90, 90′) from the drop sequence. As a result, the droplet (20) in the optical path of the light sheet microscope and also the entire droplet sequence maintain a stable position and the fluorescence measurement with the light sheet microscope can be performed. After the measurement is completed, the valves (90) and (90′) are opened again, the pumps (70, 70′) are started and the next drop (20) of the drop sequence is conveyed into the area of the window (111) of the tube probe (100). The positioning and the start of the measurement is carried out again as described above.

In the arrangement of the device (200) shown in FIG. 9, the pumps can be designed as pressure pumps (70, 70′), which preferably operate at different pressures (pressure, negative pressure), with changing pressure conditions being controlled by means of pressure sensors.

In addition to the position determination of the droplets (20) described here, position determination by means of light barriers, measuring electrodes or sensors is also possible, which would also allow the droplet velocity to be determined at the same time.

FIG. 10 shows the measuring cell (10) according to FIG. 2B with an attached metering module (160). In this metering module (160), the position and velocity of the droplets (20) are determined by means of two light barriers (162, 162′) in order to be able to shoot active substances into the droplets (20) in a defined and precise manner by means of a microvalve (visible through the cable (161)). In principle, these light barriers (162, 162′) can also be integrated directly into the measuring cell (10), for example on its side surfaces, where they do not interfere with the microscopy process. For the fluidic regime of the measuring cell (10) with metering device (160) shown here, the same boundary conditions apply in principle as for those of the light sheet microscope. The droplets (20) are to be positioned stably in the area of the optical beam path. For this purpose, the same fluidic periphery can be used as for the measurements on the light sheet microscope (see schematic in FIG. 11). In contrast to the light sheet microscope, where the door camera (41) and the Matlab software connected to it provide the switching signals for the pumps (70, 70′) and the valves (90) and (90′), here the signals would be provided by the light barriers (162, 162′) to be integrated in measuring cell (10) or the hardware connected to it for signal processing.

If the microscopes are equipped with automated object stages, in addition to positioning the droplets (20) in the sample tube, the measuring cell (10) can also be moved in three spatial directions, which is performed similarly with the tube probe (100) in the light sheet microscope (moving the entire tube probe (100) including sample tube (13) by means of piezo actuator (110)). Coupling the signal processing of the light barriers (162, 162′) with the control software of the respective microscope also opens up the possibility for automated tomographic examinations of the droplets (20).

FIG. 12B shows a stem cell spheroid (marked with a box) in a droplet (20). FIG. 12A shows the corresponding signal curve of a light barrier with clear signal changes at the phase boundaries of the drop (20) and in the area of the stem cell spheroid.

### LIST OF REFERENCE SIGNS

10 measuring cell

11 frame

12 plate of translucent material, glass plate

13 microchannel, sample tube

13′ tube

14 aqueous liquid, water, buffer, nutrient medium

15 inlet for microchannel, sample tube

16 outlet for microchannel, sample tube

17, 18 connections for conditioning tube or optical fiber

19 gasket for measuring cell housing

20 sample, drop

21 seal for microchannel

22 optical fibers

30 microscope, objective, light sheet

40 fine adjustment

41 camera, video camera, door camera

50, 50′ tube disc

60 syringe pump

70, 70′ pumps, pressure pumps

P1, P2 pressure, negative pressure

90, 90′ valve, stopcock

91, 91′ reservoir

92 pressure tube

100 tube probe

110 means for automatic movement of the tube probe, piezo actuator

111 microscopy window

120 measuring cell for light sheet microscope

130 hole for fluorescence objective

140 hole for coupling light sheet

150 range of the optical path of the optical image

160 metering device

161 micro valve

162, 162′ optical fibers

200 device

### REFERENCES

Jiang, H., et al. (2017) Droplet based light-sheet fluorescence microscopy for high-throughput sample preparation, 3-D imaging and quantitative analysis on a chip. Lab Chip, 17, 2193 ff.
Deschout, H. et al.; (2014) On-chip light sheet illumination enables diagnostic size and concentration measurements of membrane vesicles in biofluids. Nanoscale, 6(3):1741-7.

Paiè, P. et al. (2016) Selective plane illumination microscopy on a chip. Lab Chip, 16, 1556-1560.

1. Device (200) for the optical characterization of fluids and/or objects enclosed therein in a microchannel (13), comprising a measuring cell (10, 120), wherein the microchannel (13) is guided through the measuring cell (10, 120), characterized in that the measuring cell (10, 120) is filled with a liquid (14), the microchannel (13) is located within the measuring cell (10, 120) in the fluid (14), the fluid and/or objects enclosed therein are movable in the microchannel (13), and the microchannel (13) within the measuring cell (10, 120) and/or the measuring cell (10, 120) with the microchannel (13) is movable manually or automatically.

2. Device (200) according to claim 1, characterized in that the device 200) for positioning samples (20) in the microchannel 13) in the beam path of a microscope has at the inlet (15) of the microchannel (13) into the measuring cell (10, 120) or at the inlet (15) of the microchannel (13) into the measuring cell (10, 120) a pump (70) and at the outlet (16) of the microchannel (13) from the measuring cell (10, 120) a pump (70′), or at the outlet (16) of the microchannel (13) from the measuring cell (10, 120) a pump (70′).

3. Device (200) according to claim 1, characterized in that the device (200) has a valve (90) upstream of the inlet (15) of the microchannel (13) into the measuring cell (10, 120) and/or a valve (90′) downstream of the outlet (16) of the microchannel (13) from the measuring cell (10, 120) for fluidic decoupling of the pump(s) (70, 70′) from the microchannel (13).

4. Device (200) according to claim 1, characterized in that the measuring cell (10) has a closed housing and the inlet (15) of the microchannel (13) into the measuring cell (10) and the outlet (16) of the microchannel (13) from the measuring cell (10) have means for sealing (21) the microchannel (13) with respect to the housing of the measuring cell, which means allow the microchannel (13) to move within the measuring cell (10); and in that the inlet (15) of the microchannel (13) into the measuring cell (10) and the outlet (16) of the microchannel (13) from the measuring cell (10) can be arranged on each outer surface of the measuring cell (10); or p1 the measuring cell (120) has a housing which is open on one side and through which the microchannel (13) protrudes into the measuring cell (120) and out of the measuring cell (120), wherein a part of the microchannel (13) protruding into the measuring cell (120) and a part of the microchannel (13) protruding out of the measuring cell (120) are fixedly connected by means of a means (110) which is movable in all spatial directions and is not connected to the measuring cell (120), preferably by means of a piezo drive.

5. Device according to claim 1, characterized in that the measuring cell (10, 120) consists of optically transparent materials or optically non-transparent materials or of a combination or composite of optically transparent and non-transparent materials.

6. Device according to claim 1, characterized in that the measuring cell (10, 120) has connections (17, 18, 130, 140) for filling the measuring cell (10, 120) with a liquid 14), for venting the measuring cell (10, 120), for passing light sources and sensors, for example optical fibers (22) for coupling light into the measuring cell (10, 120) or light barriers (162, 162′) or electrodes for determining the position of samples (20) in the microchannel (13) or for passing through objectives (30, 30′) for emitting and detecting electromagnetic radiation.

7. Device (200) according to claim 1, characterized in that the device (200) comprises at least one means for determining the position of samples (20) in the microchannel (13), preferably at least one light barrier (162, 162′), a measuring electrode or a camera (41).

8. Measuring cell (10, 120) for the optical characterization of fluids and/or samples (20) enclosed therein in microchannels (13), wherein a microchannel (13) is led through the measuring cell (10, 120), wherein the measuring cell (10, 120) having connections (17, 18, 130, 140) for filling the measuring cell (10, 120) with a liquid (14), for venting the measuring cell (10, 120), for passing through light sources and sensors, for example optical fibers (22) for coupling light into the measuring cell (10, 120) or light barriers (162, 162′) or electrodes for determining the position of samples (20) in the microchannel (13) or for passing through objectives (30, 30′) for emitting and detecting electromagnetic radiation,
characterized in that the measuring cell (10, 120) is filled with a liquid (14), the microchannel (13) is located within the measuring cell (10, 120) in the liquid (14), and the microchannel (13) is movable within the measuring cell (10, 120) and/or the measuring cell (10, 120) with the microchannel (13) is movable manually or automatically.

9. Measuring cell (10) according to claim 8, characterized in that the measuring cell (10) comprises a closed housing and the inlet (15) of the microchannel (13) into the measuring cell (10) and the outlet (16) of the microchannel (13) from the measuring cell (10) comprise means for sealing (21) the microchannel (13) with respect to the housing of the measuring cell (10), which means allow the microchannel (13) to move within the measuring cell (10); and in that the inlet (15) of the microchannel (13) into the measuring cell (10) and the outlet (16) of the microchannel (13) from the measuring cell (10) can be arranged on each outer surface of the measuring cell (10).

10. Measuring cell (120) according to claim 8, characterized in that the measuring cell (120) has a housing open on one side, through which the microchannel (13) protrudes into and out of the measuring cell (120), wherein a part of the microchannel (13) protruding into the measuring cell (120), which part is located outside the measuring cell (120), and a part of the microchannel (13) protruding out of the measuring cell (120), which part is located outside the measuring cell (120), are fixedly connected by means of a means (110), which is movable in all spatial directions and is not connected to the measuring cell (120), preferably by means of a piezo drive.

11. Method for optically characterizing fluids and/or objects enclosed therein in a microchannel (13) by means of a device (200) or a measuring cell (10, 120) according to claim 1, wherein the microchannel (13) is located within a measuring cell (10, 120) filled with a liquid (14), comprising the steps:
a) providing a sample (20)-containing single-phase, two-phase, or multiphase fluid in a microchannel (13); and
b) positioning the samples (20) contained in the microchannel (13) in the area of the beam path of the optical image of a microscope,
characterized in that the positioning of samples (20) contained in the microchannel (13) in the region of the beam path of the optical image is effected by
c) manual axial displacement and/or rotation of the microchannel (13) relative to the measuring cell (10, 120); or
d) automatic movement of the microchannel (13) within the measuring cell (10, 120) filled with a liquid (14), preferably by means of a piezo drive (110); or
e) automatic or manual movement of the measuring cell (10, 120) filled with a liquid and containing the microchannel (13) by means of movement of the microscope stage in the three spatial directions;
and/or in that the positioning of samples (20) contained in the microchannel (13) is carried out by means of
f) moving the droplets (20) in the microchannel (13) by means of one or more pump(s) (70, 70′), and stopping the pump(s) (70, 70′) when the sample 20) is in the optical path of the optical image of a microscope; or
g) precisely moving the droplets (20) in the microchannel (13) by means of one or more pump(s) (70, 70′), stopping the pump(s) (70, 70′) and fluidically decoupling the pump(s) (70, 70′) from the droplet sequence in the microchannel (13) by means of valves (90, 90′) when the sample (20) is in the range of the beam path of the optical image of a microscope;
and/or in that the positioning of samples (20) contained in the microchannel (13) is carried out by means of
automatic detection of samples (20) in the microchannel (13) by means of a means for determining the position of the samples (20) in the microchannel (13), preferably by means of a camera (41), a measuring electrode or by means of light barriers (22, 162, 162′) and stopping the pump(s) (70, 70′) when the sample (20) is in the range of the beam path of the optical image of a microscope.
